(19) United States
(12) Patent Application Publication
(10) Pub. No.: US 2016/0122202 A1
(43) Pub. Date: May 5, 2016

(54) HAZARDOUS DRAINS PROCESS

(71) Applicant: OCS Clean Seas Pte Ltd., Singapore (SG)

(72) Inventor: Joe Marvin SHERWOOD, Singapore (SG)

(21) Appl. No.: 14/919,474

(22) Filed: Oct. 21, 2015

(30) Foreign Application Priority Data
Oct. 31, 2014 (SG) 10201407125U

(51) Int. Cl. C02F 1/00; B01D 24/48; B01D 15/18; C02F 1/28

(52) U.S. Cl. CPC C02F 1/008; C02F 1/28; C02F 1/004; B01D 24/48; B01D 15/18; C02F 2101/32

(57) ABSTRACT

The present device is an apparatus and method for processing hazardous drain flows on an offshore work platform. More particularly, the present disclosure relates to the process by which these hazardous drain flows are collected, processed and then released on an offshore work platform. This process includes phases that make up a successful treatment process: (1) coalescing, (2) particulate separation, and (3) oil absorption and adsorption. The disclosed device is the first single processing plant to capture all 3 of these necessary sub-systems onto one skid and one device.

### CROSS REFERENCE TO RELATED APPLICATIONS

This application claims priority of Application No. 1020140712.50 filed Singapore on 31 Oct. 2014 under 35 U.S.C. 119, the entire contents of which is hereby incorporated by reference.

### FIELD OF THE INVENTION

The present disclosure relates generally to an apparatus for processing of fluids, solids or liquids. In particular, the present disclosure relates to hazardous drain flows on an offshore work platform. More particularly, the present disclosure relates to the process by which these hazardous drain flows are collected, processed and then released on an offshore work platform.

### BACKGROUND OF THE INVENTION

Offshore oil rigs have several independent drain systems which do not have the ability to ‘mix’ with another. Therefore each separate drain system must be treated in its own unique manner. Treatment requirements are determined by the regional and/or governmental regulations for the release point to environment. A typical hazardous drain flow of an offshore rig can contain at least 50,000 ppm of hydrocarbons in the recovered water. Typical release point regulations requirements for this recovered water are about 40 ppm and can be required to go down to as low as 5 ppm. The process described achieves this release point capability.

Various fluids will make up any drain flow from an offshore drilling rig or work platform. These fluids can consist of fresh water, salt water, water-based muds, oil-based muds, and/or synthetic-based muds. Along with these various fluids, numerous types of foreign debris can also be part of any hazardous drain flow. The primary concern of any hazardous drain flow is two-fold: (1) the flow can contain H₂S gas and (2) can have flammable vapors. However, the main component of any rig drain flow is rain water and wash water.

Typically, storage vessels are provided on a lower level of the platform and gravity is used to provide the fluids to them. Environmental controls no longer allow washing out storage pits through the dump valves into the ocean. These residues left in an open pit mud mix carrier can be extremely difficult to displace resulting in huge vessel tank cleaning costs in port. All solvents and water used to clean the inside of the pit are also deemed hazardous and require processing as well.

Any hazardous drain flow from within an offshore rig or work platform will come from all areas in which the drill muds can enter the drain system. For instance (a) rig floors, (b) shaker decks or areas, (c) secondary cuttings processing, and (d) mud mix area, are all examples of drain systems that will handle the drill muds to some capacity. The process and skid described herein is designed to treat this hazardous drain flow in offshore drilling.

### SUMMARY OF THE INVENTION

Due to the uncontrolled nature of hazardous drain flow on any offshore drilling rig, several processes must interact with one another to achieve the final product. This device provides multiple processes on one 20 ft, ISO dimensioned DNV 2.7.1 skid frame. Numerous devices can process a portion of the drain flow. Many of these single purpose devices originate from existing industries (tankers, cruise ships, etc). Only in the past few years has the upstream petroleum industry started to consider solutions to their drains make-up.

All of these single purpose devices may work on their dedicated phase of the overall process. In total, there are three necessary phases that make up a successful treatment process: (1) coalescing, (2) particulate separation, and (3) oil absorption and adsorption. The disclosed process is the first single process to capture all 3 of these necessary sub-systems onto one skid and one device. All existing competitors utilize multiple skids and different manufacturers or vendors for each skid.

An embodiment disclosed herein involves the use of a coalescer, particulate filtration, oil bonding cartridges, water-oil analyzer (2 probes), dense phase level switch, water level switch (activates pump), dense phase pump, free oil gravity tube, skid vacuum tank, 3 way valves. The single complete process is designed for the upstream petroleum hazardous drains market. All others have taken existing technology and ‘adapted’ or ‘converted’ them to try to handle the difficulties which only the upstream petroleum industry presents.

Another aspect of the design is that several emerging technologies can be incorporated within the same process skid. The coalescing body should be placed upstream of the water clarifier as the water clarifier will perform better with the coalescer placed upstream of it. The particulate filter and the oil bonding cartridge housing can be replaced with a new, emerging technology. We have designed our skid to allow the filter POD/housing system to be replaced with any newer technology that the end-user wishes to test or include in their process.

This process is made up of multiple already proven technologies. The disclosed system on the skid is the first time all these technologies are made to work in association with one another. What makes this process unique is that this system allows all these individual processes “communicate” with one another and thus are able to “automate” the entire skid which results in better performance and requires fewer personnel onboard the vessel to operate the process.

The process above is further described as follows. The feed stock is “pre-qualified” prior to entry into the process, using one of two probes in the water/oil analyzer. So if the feed stock already meets the specifications for release, the liquid can bypass the process.

The second probe is hooked up to the same analyzer to take readings from the processed flow and qualifies it as being able to be discarded (if it is within release specifications) or recycled back through the process.

The water-oil analyzer is set up to be globally ready. This is done by pre-entering globally strategic release set points into the PLC (programmable logic controller). This adjusts the flow rate of the process automatically depending on the regional set-point requirements. Currently no system creates global set points which control pump feed rate. Some examples of regional set points are shown below:

TABLE 1

| | |
|---|---|
| Selection 1 | (<5 ppm) pump at 5 m³/hr |
| Selection 2 | (<10 ppm) pump at 10 m³/hr |
| Selection 3 | (<30 ppm) pump at 25 m³/hr |
| Selection 4 | (<29 ppm) pump at 25 m³/hr |
| Selection 5 | (<40 ppm) pump at 30 m³/hr |

The system prequalifies the feed stock in a coalescing body, and then pumps it from the coalescer into a particulate filter to then be sent to the oil bonding cartridges.

All aspects of the process are automated, when it comes to flow routing, dense phase level detection then auto pump off, recovered water level detection then auto pump off. Prior to this process, all the individual sub-components operated independently of one another, with all being provided by different service companies. Thus, one process could not take into account what the other one was doing. With this automation all these components act as one more efficient process.

The following items can be monitored and controlled to by the operator and also communicate with one another: (a) inlet 3-way valve flow routing, (b) outlet 3-way valve flow routing, (c) recovered water pump speed via globally pre-set release points, (d) dense phase level detection then auto pump off, (e) recovered water detection then auto pump off, (f) an optional H2S monitor, and (g) an optional heater. This process has a dual role onboard an exploration worksite. It is designed for hazardous drains processing but can also be assigned to the brine completions fluid clean up role as well.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a front view of the system placed on a skid; and

FIG. 2 is a rear view of the system on the skid.

### DETAILED DESCRIPTION

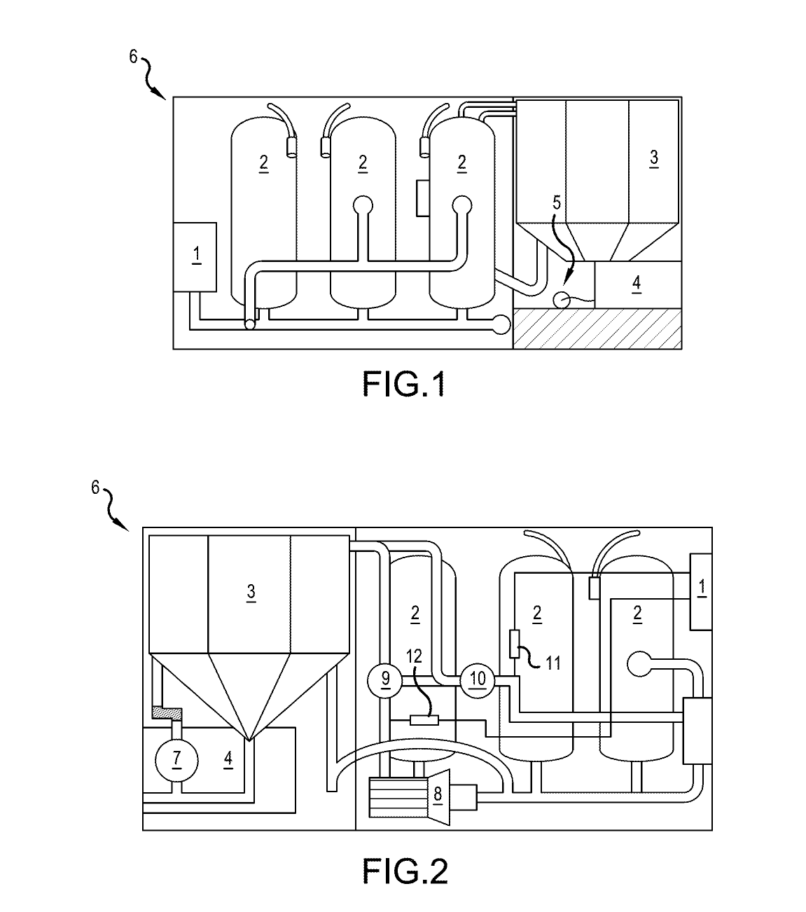

The embodiments disclosed relate to a hazardous drain process and system 6 designed within a specific skid, the skid being an ISO dimensioned 20 ft container-style skid. FIG. 1 shows a coalescing body or tank 3. This tank 3 is fed by a vacuum recovery tank 4 connected to the hazardous drain of a barge or oil rig. A vacuum pump 5 ensures that the pressure in the drain is less than that of the environment.

The coalescing tank 3 pre-treats the erratic hazardous drain flow before entry into any filter or downstream system. The removal of any free-oils and any dense phase is done within this body through a strainer, lamella insert (removable), and retention weirs using specific gravity to accomplish the segregation role.

The system also includes a “polishing” stage or filtration stage 2. The polishing stage is made up of three separate vessels or PODs. Each POD is designed to hold filters and/or cartridges and can withstand up to 7 bar of pressure. All PODs are industry standard sized and will allow adaptation of the filter or cartridge selection according to user preferences.

As designed, recovered but dirty water is pumped from the upstream coalescing tank 3 into the first POD. Here particulate filters are used for the removal of any suspended solids still in the recovered stream. The removal of particulates helps protect the following cartridges in the second and third PODs. Micron sizing of these particulate filters in the first POD can be between 2μ-100μ. The first POD can use seven size 6.25 inch×40 inch filters.

The second and third POD are in place to handling any oil recovery (bonding) but these PODs are not limited to this role. Again, industry standard sizing of each POD allows for the end-user to choose what is best suited for a particular need. As designed, the second and third PODs contain oil bonding cartridges which allow end-user to recover (bond) any oil that remains in the recovered water flow. The slower flow is moved through these cartridges, the greater the recovery down to less than 5 ppm hydrocarbon carryover. The second and third PODs allow for 46 cartridges each, of size 2.5 inch×40 inch.

The polishing phase of the process gives the end-user the ability to use a primary particulate filter and a secondary oil absorbing filter. Different types of filters can be used depending on style, cost, and/or degree of cleaning necessary. The polishing stage 2 is fed by the dense phase pump 7.

The system also includes a dedicated positive displacement water pump 8 which is activated by a water level switch. This pump picks up the recovered water from the hazardous drain flow within the coalescing body and pushes the recovered but dirty water through a series of filters during the polishing stage.

The process is monitored by a water-oil analyzer 1 which uses dual probes placed both before entry into the coalescer and after exit from the filters. Each probe controls a three-way valve, one three-way valve at the inlet 10 and another three-way valve at the exit 9. Each three-way valve directs flow according to a particular job protocol based on the requirements for release.

The probes look for “off-spec” products or “under spec” outputs which must be re-processed. Prior to entry into the process, the first probe 11 determines if the feed stock already meets the specifications for release. If so, the liquid can bypass the process and be released. If not, then the liquid enters the process. The second probe 12 is hooked up to the same analyzer to take readings from the processed flow and determines when it has been filtered adequately. If the tested water meets the preset requirements, the flow is discarded. If not, the water mixture is recycled back through the process.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure that are known or customary practice in the art to which this invention pertains.

What is claimed is:

1. A hazardous drains processing system, comprising:
a coalescer which pre-treats the drain flow;
a polisher which filters the pre-treated drain flow; and
a water-oil analyzer, the analyzer measuring impurities and directing fluid flow within the system.

2. The hazardous drains processing system of claim 1, further comprising:
an exit valve probe; and
an inlet valve probe, wherein the exit valve probe and the inlet valve probe communicate with the water analyzer and measure impurities in the fluid flow.

3. The hazardous drains processing system of claim 2, further comprising:
an inlet three-way valve; and
an exit three-way valve, wherein the inlet three-way valve and the exit three-way valve control flow based on the measurements of the exit valve probe and the inlet valve probe.

4. The hazardous drains processing system of claim 2, wherein the water-oil analyzer has preset set points for fluid purity.

5. The hazardous drains processing system of claim 4, wherein the preset set points correspond to international environmental release regulations.

6. The hazardous drains processing system of claim 4, wherein the water-oil analyzer compares the measurements the exit valve probe and the inlet valve probe to the preset set points to determine if the water can be released.

7. The hazardous drains processing system of claim 6, wherein if the measured impurities are less than an appropriate preset set point, then the fluid is released, and wherein if the measured impurities are greater than the appropriate preset set point, then the fluid is returned to the polisher.

8. The hazardous drains processing system of claim 1, wherein the polisher includes a primary particulate filter and a secondary oil absorbing filter.

9. A hazardous drains processing system, comprising:
separator means for pre-treating the drain flow;
filtering means for filtering the pre-treated drain flow;
water-oil analyzer means for analyzing chemical concentrations in a flow;
first probe means at an exit valve for measuring impurities in the flow;
second probe means at an inlet valve for measuring impurities in the flow, wherein the first probe means and the second probe means communicate with the water analyzer,
inlet three-way valve means for controlling a direction of the flow; and
exit three-way valve means for controlling a direction of the flow, wherein the inlet three-way valve means and the exit three-way valve means control flow based on the measurements of the exit valve probe and the inlet valve probe.

10. A hazardous drains treatment method, comprising:
separating and pre-treating the drain flow with a coalescer;
polishing the pre-treated flow with at least one filter;
measuring a plurality of impurities in the drain flow;
analyzing the plurality of impurities in the drain flow and comparing the measured plurality of impurities with a preset set point;
controlling a flow within the system based on the comparison; and
releasing water into the environment if the measured plurality of impurities are below a preset set point.

11. The hazardous drains treatment method of claim 10, further comprising:
measuring the fluid impurities with a first probe before an inlet valve; and
measuring the fluid impurities with a second probe before an exit valve, wherein first and second probes communicate with a water analyzer.

12. The hazardous drains treatment method of claim 11, wherein an inlet three-way valve and a exit three-way valve control flow based on the measurements of the first probe and the second probe.

13. The hazardous drains treatment method of claim 10, wherein the preset set points correspond to international environmental release regulations.

14. The hazardous drains processing system of claim 10, and wherein if the measured impurities are greater than an appropriate preset set point, then the flow is returned to the polishing step.
